(19) United States
(12) Patent Application Publication
(10) Pub. No.: US 2026/0281048 A1
(43) Pub. Date: Sep. 17, 2026

(54) PROTOCOL DATA UNIT SET IMPORTANCE BASED DISCARD

(71) Applicant: Lenovo (Beijing) Limited, Beijing (CN)

(72) Inventors: Mingzeng Dai, Shanghai (CN); Xiaoying Xu, Shanghai (CN); Haiyan Luo, Shanghai (CN)

(73) Assignee: Lenovo (Beijing) Limited, Beijing (CN)

(21) Appl. No.: 19/480,105

(22) PCT Filed: Dec. 8, 2023
(86) PCT No.: PCT/CN2023/137637

§ 371 Date: Oct. 30, 2025

(51) Int. Cl. H04L 47/32

(52) U.S. Cl. CPC H04L 47/32

(57) ABSTRACT

Various aspects of the present disclosure relate to PSI based discard. In one aspect, a first network node determines a first indication and transmits the first indication to a second network node. The first indication may be used to determine, by the second network node, deactivation of PSI based discard for a DRB or release of configuration of the PSI based discard for the DRB.

### TECHNICAL FIELD

The present disclosure relates to wireless communications, and more specifically to network nodes and methods performed by the network nodes for supporting protocol data unit set importance (PSI) based discard.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A concept of a Protocol Data Unit (PDU) Set is introduced for Extended Reality (XR) services. A PDU Set may comprise one or more PDUs carrying a payload of one unit of information generated at an application level. For example, the unit of information may be a frame or video slice for XR services. In some implementations, all PDUs in a PDU Set are needed by an application layer to use the corresponding unit of information. In other implementations, the application layer can still recover part or all of the information unit when some PDUs in the PDU Set are missing.

PDU Sets may carry different contents with different importance levels. A PSI value or PSI level may identify the relative importance of a PDU Set compared to other PDU Sets within a QoS Flow. A PDU Set with high importance may still be needed in the decoding of subsequent PDU Sets, even after it misses its own decoding deadline (PSDB).

Besides the legacy Packet Data Convergence Protocol (PDCP) discard timer, an additional or new PDCP discard timer for low or lower importance PDU Set may be used for a PDCP entity of a Data Radio Bearer (DRB) in uplink (UL) if a network node activates PSI based discard. There is a need to study how to align activation or deactivation of the PSI based discard between the network node and UE when reconfiguration of the PSI based discard is performed.

### SUMMARY

The present disclosure relates to network nodes and methods that support PSI based discard. With the network nodes and methods, activation or deactivation of PSI based discard may be aligned between a network node and UE when reconfiguration of PSI based discard is performed.

Some implementations of a first network node described herein may include a processor and a transceiver coupled to the processor, wherein the processor is configured to: configure a user equipment (UE) with protocol data unit set importance (PSI) based discard for a DRB; determine to reconfigure the UE with the PSI based discard for the DRB; and transmit a first indication via the transceiver to a second network node, wherein the first indication is used to determine deactivation of the PSI based discard for the DRB by the second network node.

In some implementations, the processor is configured to transmit the first indication by: transmitting, to the second network node, first information about configuration or reconfiguration of the PSI based discard for the DRB. In some implementations, the first information is used to determine deactivation of the PSI based discard for the DRB by the second network node.

In some implementations, the processor is configured to transmit the first information about configuration or reconfiguration of the PSI based discard for the DRB by transmitting one of the following: a UE CONTEXT MODIFICATION REQUEST message which comprises the first information, or a SECONDARY NODE MODIFICATION REQUEST message which comprises the first information.

In some implementations, the processor is configured to transmit the first indication by: transmitting a message comprising an indicator to the second network node. In some implementations, the indicator is used to determine deactivation of the PSI based discard for the DRB by the second network node.

In some implementations, the message comprises one of the following: a UE CONTEXT MODIFICATION REQUEST message which comprises the indicator, or a SECONDARY NODE MODIFICATION REQUEST message which comprises the indicator.

In some implementations, the processor is further configured to: upon configuring the UE with the PSI based discard for the DRB, transmit a second indication to the second network node. In some implementations, the second indication is used to determine deactivation of the PSI based discard for the DRB by the second network node.

In some implementations, the processor is configured to transmit the second indication by: transmitting, to the second network node, second information about configuration of the PSI based discard for the DRB. In some implementations, the second information is used to determine deactivation of the PSI based discard for the DRB by the second network node.

In some implementations, the processor is configured to transmit the second information about configuration of the PSI based discard for the DRB by transmitting one of the following: a UE CONTEXT SETUP REQUEST message which comprises the second information, or a SECONDARY NODE ADDITION REQUEST message which comprises the second information.

In some implementations, the processor is further configured to: transmit a third indication to the second network node. In some implementations, the third indication is used to determine release of configuration of the PSI based discard for the DRB by the second network node.

In some implementations, the first network node comprises a central unit (CU) of a gNodeB, and the second network node comprises a distributed unit (DU) of the gNodeB.

In some implementations, the first network node comprises a node hosting a packet data convergence protocol (PDCP) entity of the DRB, and the second network node comprises a peer node of the node hosting the PDCP entity.

Some implementations of a second network node described herein may include a processor and a transceiver coupled to the processor, wherein the processor is configured to: receive a first indication via the transceiver from a first network node, wherein the first indication is used to determine deactivation of PSI based discard for a DRB by the second network node; and determine, based on the first indication, the deactivation of the PSI based discard timer for the DRB.

In some implementations, the processor is configured to receive the first indication by: receiving, from the first network node, first information about configuration or reconfiguration of the PSI based discard for the DRB. In some implementations, the first information is used to determine deactivation of the PSI based discard for the DRB by the second network node.

In some implementations, the processor is configured to receive the first information about configuration or reconfiguration of the PSI based discard for the DRB by receiving one of the following: a UE CONTEXT MODIFICATION REQUEST message which comprises the first information, or a SECONDARY NODE MODIFICATION REQUEST message which comprises the first information.

In some implementations, the processor is configured to receive the first indication by: receiving a message comprising an indicator from the first network node. In some implementations, the indicator is used to determine deactivation of the PSI based discard for the DRB by the second network node.

In some implementations, the message comprises one of the following: a UE CONTEXT MODIFICATION REQUEST message which comprises the indicator, or a SECONDARY NODE MODIFICATION REQUEST message which comprises the indicator.

In some implementations, the processor is further configured to: after the UE is configured with the PSI based discard for the DRB, receive a second indication from the first network node. In some implementations, the second indication is used to determine deactivation of the PSI based discard for the DRB by the second network node.

In some implementations, the processor is configured to receive the second indication by: receiving, from the first network node, second information about configuration of the PSI based discard for the DRB. In some implementations, the second information is used to determine deactivation of the PSI based discard for the DRB by the second network node.

In some implementations, the processor is configured to receive the second information about configuration of the PSI based discard for the DRB by receiving one of the following: a UE CONTEXT SETUP REQUEST message which comprises the second information, or a SECONDARY NODE ADDITION REQUEST message which comprises the second information.

In some implementations, the processor is further configured to: receive a third indication from the first network node. In some implementations, the third indication is used to determine release of configuration of the PSI based discard for the DRB by the second network node.

In some implementations, the first network node comprises a central unit (CU) of a gNodeB, and the second network node comprises a distributed unit (DU) of the gNodeB.

In some implementations, the first network node comprises a node hosting a packet data convergence protocol (PDCP) entity of the DRB, and the second network node comprises a peer node of the node hosting the PDCP entity.

Some implementations of a first network node described herein may include a processor and a transceiver coupled to the processor, wherein the processor is configured to: transmit, via the transceiver to a second network node, information about configuration of downlink PSI based discard for at least one DRB; and receive, via the transceiver from the second network node, an indication indicating whether to activate the downlink PSI based discard for the at least one DRB.

In some implementations, the processor is configured to receive the indication by: receiving, from the second network node, a General Packet Radio Service (GPRS) Tunnel Protocol-User Plane (GTP-U) extension header which comprises the indication.

In some implementations, the GTP-U extension header comprises a bitmap, each of at least one bit in the bitmap is associated with one of the at least one DRB, and each of the at least one bit indicates whether to activate the downlink PSI based discard for a respective one of the at least one DRB.

Some implementations of a second network node described herein may include a processor and a transceiver coupled to the processor, wherein the processor is configured to: receive, via the transceiver from a first network node, information about configuration of at least one downlink PSI based discard for at least one DRB; and transmit, via the transceiver to the first network node, an indication indicating whether to activate the at least one downlink PSI based discard for the at least one DRB.

In some implementations, the processor is configured to transmit the indication by: transmitting, to the first network node, a General Packet Radio Service (GPRS) Tunnel Protocol-User Plane (GTP-U) extension header which comprises the indication.

In some implementations, the GTP-U extension header comprises a bitmap, each of at least one bit in the bitmap is associated with one of the at least one DRB, and each of the at least one bit indicates whether to activate the downlink PSI based discard for a respective one of the at least one DRB.

Some implementations of a method described herein may include: configuring a UE with PSI based discard for a DRB; determining to reconfigure the UE with the PSI based discard for the DRB; and transmitting a first indication to a second network node, wherein the first indication is used to determine deactivation of the PSI based discard for the DRB by the second network node.

Some implementations of a method described herein may include: receiving a first indication from a first network node, wherein the first indication is used to determine deactivation of PSI based discard for a DRB by the second network node; and determining, based on the first indication, the deactivation of the PSI based discard timer for the DRB.

Some implementations of a method described herein may include: transmitting, to a second network node, information about configuration of downlink PSI based discard for at least one DRB; and receiving, from the second network node, an indication indicating whether to activate the downlink PSI based discard for the at least one DRB.

Some implementations of a method described herein may include: receiving, from a first network node, information about configuration of at least one downlink PSI based discard for at least one DRB; and transmitting, to the first network node, an indication indicating whether to activate the at least one downlink PSI based discard for the at least one DRB.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1 illustrates an example of a wireless communications system that supports PSI based discard in accordance with aspects of the present disclosure;

FIG. 2 illustrates another example of a wireless communications system that supports PSI based discard in accordance with aspects of the present disclosure;

FIGS. 3 to 11 illustrate a signaling diagram illustrating an example process that supports PSI based discard in accordance with aspects of the present disclosure, respectively;

FIG. 12 illustrates an example of a device that supports PSI based discard in accordance with some aspects of the present disclosure; and

FIGS. 13 to 16 illustrate a flowchart of a method that supports PSI based discard in accordance with aspects of the present disclosure, respectively.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, an additional PDCP discard timer for low or lower importance PDU Set may be used for a PDCP entity of a DRB in UL. The additional PDCP discard timer may be configured by an RRC layer for a PDCP entity and a value of the additional PDCP discard timer may be configured shorter than that of the legacy PDCP discard timer.

Furthermore, a network node may activate or deactivate PSI based discard by transmitting a PSI-Based Service Data Unit (SDU) Discard Activation/Deactivation MAC CE to a UE. For example, when the network node is congested, the network node can activate the PSI based discard. Otherwise, the network node can deactivate the PSI based discard.

An initial state of the PSI-Based SDU Discard Activation/Deactivation MAC CE may be deactivated. The PSI based discard may be initially deactivated upon (re-) configuration by RRC layers and after reconfiguration with synchronization. Therefore, there is a need to study how to align activation or deactivation of the PSI based discard between the network node and UE when reconfiguration of the PSI based discard is performed.

In view of the above, the present disclosure provides a solution that supports PSI based discard. In this solution, a first network node determines a first indication and transmits the first indication to a second network node. The first indication may be used to determine, by the second network node, deactivation of PSI based discard for a DRB or release of configuration of the PSI based discard for the DRB. In this way, activation or deactivation of PSI based discard may be aligned between a network node and UE when reconfiguration of PSI based discard is performed.

Aspects of the present disclosure are described in the context of a wireless communications system.

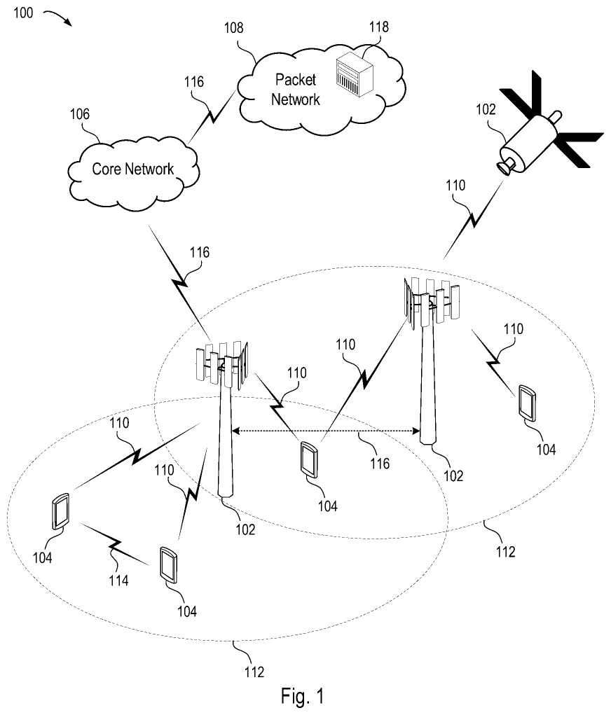

FIG. 1 illustrates an example of a wireless communications system 100 that supports PSI based discard in accordance with aspects of the present disclosure. The wireless communications system 100 may include one at least one of network entities 102 (also referred to as network equipment (NE)), one or more terminal devices or UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The network entities 102 may be dispersed throughout a geographic region to form the wireless communications system 100. One or more of the network entities 102 described herein may be or include or may be referred to as a network node, a base station (BS), a network element, a radio access network (RAN) node, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface. The network entities 102 may be collectively referred to as network entities 102 or individually referred to as a network entity 102. Hereinafter, some implementations of the present disclosure will be described by taking a gNB as an example of the network entity 102. Thus, the network entity 102 may be used interchangeably with the gNB 102. For example, the gNBs 102 may comprise a gNB 102-1 and a gNB 102-2, as shown in FIG. 1.

In some implementations, the gNB 102 may support dual connectivity (DC) operation. For example, the gNB 102-1 may act as a master RAN node and the gNB 102-2 may act as a secondary RAN node. Hereinafter, for brevity, a master RAN node is also referred to as a master node (MN) and a secondary RAN node is also referred to as a secondary node (SN).

In some implementations, MCG may be a group of serving cells associated with the Master RAN Node, comprising a Special Cell (SpCell) which is known as a Primary Cell (PCell) and optionally one or more Secondary Cells (SCells).

In some implementations, for a UE 104 configured with dual connectivity, SCG may be a subset of serving cells comprising a Primary Secondary Cell (PSCell) and zero or more SCells.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, p=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (510 MHz-7.125 GHZ), FR2 (24.25 GHZ-52.6 GHz), FR3 (7.125 GHz-24.25 GHZ), FR4 (52.6 GHZ-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

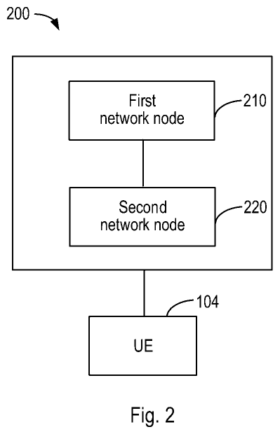

FIG. 2 illustrates another example of a wireless communications system 200 that supports PSI based discard in accordance with aspects of the present disclosure. As shown in FIG. 2, the network entity 102 may comprise a first network node 210, a second network node 220 and the UE 104.

In some implementations, each of the first network node 210 and the second network node 220 may be implemented as one of the following: a gNB, a base station, a network element, a RAN node, a base transceiver station, an access point, a NodeB, or an eNB.

In some implementations, the UE 104 may be in dual connection (DC) with the first network node 210 and the second network node 220. In such implementations, the first network node 210 may be implemented as a node hosting PDCP entity, and the second network node 220 may be implemented as a peer node (also referred to as a corresponding node). In other words, a PDCP entity of a DRB may be terminated in the first network node 210, and the lower layers of the DRB is served by the second network node 220. For example, the DRB may be one of the following: a split bearer, or SN terminated MCG bearer or MN terminated SCG bearer. The lower layers of the DRB may comprise an RLC entity and a MAC entity of the DRB.

In some implementations, the node hosting PDCP entity may be an MN, and the peer node may be an SN. Alternatively, the node hosting PDCP entity may be an SN and the peer node may be an MN.

Alternatively, in some implementations, the first network node 210 and the second network node 220 may be collectively implemented as a gNB. For example, the first network node 210 may be implemented as a gNB-CU, and the second network node 220 may be implemented as a gNB-DU. The gNB-CU and the gNB-DU may be connected via F1 interface. In such implementations, the node hosting PDCP entity may be a gNB-CU having a PDCP entity of a DRB, and the peer node may be a gNB-DU having RLC and MAC entities of the DRB.

In some implementations, the gNB-CU may be a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU.

In some implementations, the gNB-DU may be a logical node hosting RLC, MAC and PHY protocols of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

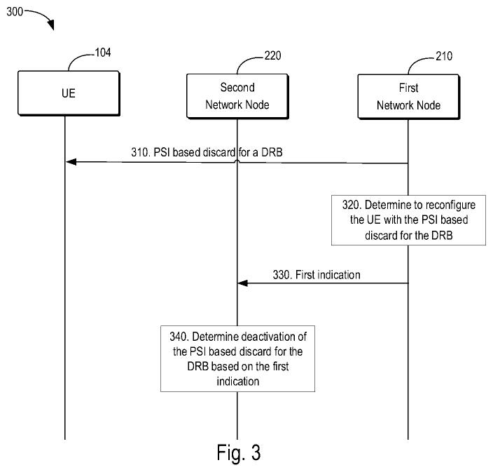

FIG. 3 illustrates a signaling diagram illustrating an example process 300 that supports PSI based discard in accordance with aspects of the present disclosure. The process 300 may involve the UE 104, the first network node 210 and the second network node 220 in FIG. 2. For the purpose of discussion, the process 300 will be described with reference to FIG. 2.

As shown in FIG. 3, the first network node 210 configures 310 the UE 104 with PSI based discard for a DRB. In other words, the first network node 210 configures the UE 104 with PSI based discard function or mechanism for a DRB.

In some implementations, upon configuration of the PSI based discard, the PSI based discard may be initially deactivated. In other words, upon receiving the configuration of the PSI based discard, the UE 104 determines that the PSI based discard is deactivated.

Hereinafter, PSI based discard may be also referred to as PSI based SDU discard.

In some implementations, during configuring the UE 104 with PSI based discard for a DRB, the first network node 210 may configure the UE 104 with a first value of a PSI based discard timer for the DRB. The PSI based discard timer may be also referred to as one of the following: a discard timer for low or lower importance, a discard timer for low or lower importance data, or a discard timer for low or lower importance PDU Set.

In some implementations, a PSI value of a PDU Set is of low or lower importance, and identification of PSI of PDU Set and determination of low or lower importance PDU Set may be based on UE implementation.

In some implementations, at reception of a PDCP SDU from upper layers, if the PSI based discard is configured and activated and if the PDCP SDU belongs to low importance data (e.g., the PDCP SDU is associated with a PSI value), the transmitting PDCP entity of the UE 104 may start the PSI based discard timer associated with this PDCP SDU. If the PSI based discard is deactivated and/or the PDCP SDU does not belong to low importance data (e.g., the PDCP SDU is not associated with the PSI value), the transmitting PDCP entity of the UE 104 may start a legacy PDCP discard timer associated with this PDCP SDU (if configured).

Then, the first network node 210 determines 320 to reconfigure the UE 104 with the PSI based discard for the DRB. In other words, the first network node 210 determines to reconfigure the UE 104 with the PSI based discard function or mechanism for the DRB.

In some implementations, during reconfiguring the UE 104 with the PSI based discard for the DRB, the first network node 210 may reconfigure the UE 104 with a second value of the PSI based discard timer for the DRB. The second value of the PSI based discard timer may be different from the first value of the PSI based discard timer.

In turn, the first network node 210 transmits a first indication to the second network node 220. The first indication is used to determine, by the second network node 220, deactivation of the PSI based discard for the DRB.

Upon receiving the first indication, the second network node 220 determines 340, based on the first indication, deactivation of the PSI based discard for the DRB.

With the process 300, deactivation of PSI based discard may be aligned between the network node 220 and the UE 104 when reconfiguration of PSI based discard is performed.

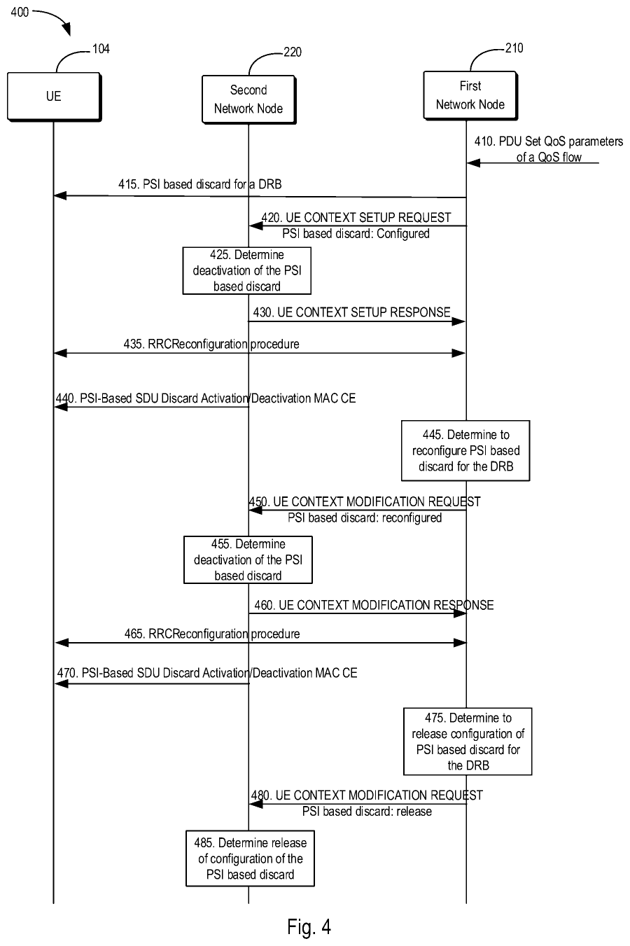

In some implementations, the first network node 210 may transmit the first indication by transmitting, to the second network node 220, first information about configuration or reconfiguration of the PSI based discard for the DRB. The first information is used to determine, by the second network node 220, deactivation of the PSI based discard for the DRB. This will be described with reference to FIG. 4.

FIG. 4 illustrates a signaling diagram illustrating an example process 400 that supports PSI based discard in accordance with aspects of the present disclosure. The process 400 may be considered as an example implementation of the process 300. The process 400 may involve the UE 104, the first network node 210, the second network node 220 in FIG. 2. For the purpose of discussion, the process 400 will be described with reference to FIG. 2.

Generally, in the process 400, the first network node 210 may be implemented as a gNB-CU, and the second network node 220 may be implemented as a gNB-DU. The first network node 210 transmits, to the second network node 220, the first information about reconfiguration of the PSI based discard for the DRB. The first information is used to determine, by the second network node 220, deactivation of the PSI based discard for the DRB.

As shown in FIG. 4, the first network node 210 receives 410 PDU Set QoS parameters of a QoS flow from the CN 106 or from another gNB. For example, the first network node 210 may receive PDU Set QoS parameters of a QoS flow in a PDU Session Setup Request message from the CN 106. Alternatively, the first network node 210 may receive PDU Set QoS parameters of a QoS flow in Handover Request message from another gNB. The PDU Set QoS parameters may comprise at least one of the following: PDU Set Delay Budget (PSDB), PDU Set Error Rate (PSER) and PDU Set Integrated Handling Information (PSIHI).

The first network node 210 may determine to configure a PSI based discard timer for a DRB that the QoS flow is mapped to according to the received PDU Set QoS parameters. In turn, the first network node 210 configures 415 the UE 104 with PSI based discard for the DRB. The action 415 is similar to the action 310 in FIG. 3. Details of this action is omitted for brevity.

In some implementations, upon configuration of the PSI based discard, the PSI based discard may be initially deactivated. In other words, upon receiving the configuration of the PSI based discard, the UE 104 determines that the PSI based discard is deactivated.

Upon configuring the UE 104 with the PSI based discard for the DRB, the first network node 210 may transmit a second indication to the second network node 220. The second indication is used to determine deactivation of the PSI based discard for the DRB by the second network node 220.

In some implementations, the first network node 210 may transmit the second indication by transmitting second information about configuration of the PSI based discard for the DRB. The second information about configuration of the PSI based discard for the DRB indicates that a configuration state of PSI based discard for the DRB is “configured” or indicates that the PSI based discard for the DRB is “configured”. The second information is used to determine deactivation of the PSI based discard for the DRB by the second network node 220.

For example, as shown in FIG. 4, the first network node 210 may transmit 420 a UE CONTEXT SETUP REQUEST message to the second network node 220. The UE CONTEXT SETUP REQUEST message may comprise a DRB to Be Setup List information element (IE). The DRB to Be Setup List IE may comprise the second information about configuration of the PSI based discard for the DRB. Table 1 gives an example of the DRB to Be Setup List IE.

TABLE 1

```
DRB to Be Setup List
  >DRB to Be Setup Item IEs
    >>DRB ID
    >>PSI based discard
```

As shown in Table 1, the DRB to Be Setup List IE may comprise DRB to Be Setup Item IEs. The DRB to Be Setup Item IEs may comprise a “DRB ID” field and a “PSI based discard” IE. A value of the “PSI based discard” IE may indicate a configuration state of PSI based discard for the DRB identified by the “DRB ID” IE.

In some implementations, the “PSI based discard” IE may comprise three code points. For example, PSI based discard::=ENUMERATED {configured, reconfigured, release, . . . }. A value of the “PSI based discard” IE set to “configured” may indicate the configuration state of PSI based discard for the DRB is “configured”. The value of the “PSI based discard” IE set to “reconfigured” may indicate the configuration state of PSI based discard for the DRB is “reconfigured”. The value of the “PSI based discard” IE set to “release” may indicate the configuration state of PSI based discard for the DRB is “release” or indicate the configuration of PSI based discard for the DRB is released. In the action 420, the value of the “PSI based discard” IE is set to “configured”. In such implementations, a single IE with three code points are used to indicate whether the PSI based discard is configured, reconfigured or released when the second network node 220 determines to configure, reconfigure and release the PSI based discard. Thus, misunderstanding of the second network node 220 may be avoided.

In some implementations, optionally, the first network node 210 may also indicate the first value of the PSI based discard timer (e.g., 50 ms) to the second network node 220.

When the second network node 220 receives the second information about configuration of the PSI based discard for the DRB, the second network node 220 determines 425, based on the second information, deactivation of the PSI based discard for the DRB. For example, when the second network node 220 receives the “PSI based discard” IE with the value “configured”, the second network node 220 determines the PSI based discard for the DRB is configured to the UE 104 and the state of PSI based discard is deactivated. In this way, deactivation of PSI based discard is aligned between the network node 220 and the UE 104.

In some implementations, optionally, the second network node 220 may transmit 430 a UE CONTEXT SETUP RESPONSE message to the first network node 210.

In some implementations, optionally, an RRC Reconfiguration procedure may be performed 435 between the UE 104 and the first network node 210.

Then, for example, if the second network node 220 detects UL congestion, the second network node 220 may transmit 440 a PSI-Based SDU Discard Activation/Deactivation MAC CE to the UE 104 to activate the PSI based discard for the DRB. In this way, activation of PSI based discard may be aligned between the network node 220 and the UE 104 when reconfiguration of PSI based discard is performed.

The first network node 210 may determine to change the first value of the PSI based discard timer for the DRB. In this case, the first network node 210 may determine 445 to reconfigure the UE 104 with the PSI based discard. For example, the first network node 210 may determine to change the first value of the PSI based discard timer for the DRB to the second value of the PSI based discard timer for the DRB. In this case, the first network node 210 may determine to reconfigure the UE 104 with the second value of the PSI based discard timer for the DRB.

The first network node 210 transmits the first indication by transmitting the first information about reconfiguration of the PSI based discard for the DRB. The first information about reconfiguration of the PSI based discard for the DRB indicates that a configuration state of PSI based discard for the DRB is “reconfigured” or indicates that the PSI based discard for the DRB is “reconfigured”. The first information is used to determine deactivation of the PSI based discard for the DRB by the second network node 220.

For example, as shown in FIG. 4, the first network node 210 may transmit 450 a UE CONTEXT MODIFICATION REQUEST message to the second network node 220. The UE CONTEXT MODIFICATION REQUEST message may comprise a DRB to Be Modify List IE. The DRB to Be Modify List IE may comprise the first information about reconfiguration of the PSI based discard for the DRB.

For example, the DRB to Be Modify List IE may comprise DRB to Be Modify Item IEs. The DRB to Be Modify Item IEs may comprise a “DRB ID” field and the “PSI based discard” IE. The value of the “PSI based discard” IE may indicate the configuration state of PSI based discard for the DRB identified by the “DRB ID” IE.

As described above, in some implementations, the “PSI based discard” IE may comprise the three code points. In the action 450, the value of the “PSI based discard” IE is set to “reconfigured”, which indicates the configuration state of PSI based discard for the DRB is “reconfigured”.

In some implementations, optionally, the first network node 210 may also indicate the second value of the PSI based discard timer to the second network node 220.

When the second network node 220 receives the first information about reconfiguration of the PSI based discard for the DRB, the second network node 220 determines 455, based on the first information, deactivation of the PSI based discard for the DRB. For example, when the second network node 220 receives the “PSI based discard” IE with the value “reconfigured”, the second network node 220 determines the PSI based discard for the DRB is reconfigured to the UE 104 and the state of PSI based discard is deactivated.

In some implementations, optionally, the second network node 220 may transmit 460 a UE CONTEXT MODIFICATION RESPONSE message to the first network node 210.

In some implementations, optionally, an RRC Reconfiguration procedure may be performed 465 between the UE 104 and the first network node 210.

Then, for example, if the second network node 220 detects UL congestion, the second network node 220 may transmit 470 a PSI-Based SDU Discard Activation/Deactivation MAC CE to the UE 104 to activate the PSI based discard for the DRB.

The first network node 210 may determine 475 to release configuration of the PSI based discard to the UE 104. In this case, the first network node 210 releases the configuration of the PSI based discard to the UE 104.

In turn, the first network node 210 may transmit a third indication to the second network node 220. The third indication is used to determine, by the second network node 220, release of configuration of the PSI based discard for the DRB.

For example, as shown in FIG. 4, the first network node 210 may transmit 480 a UE CONTEXT MODIFICATION REQUEST message to the second network node 220. The UE CONTEXT MODIFICATION REQUEST message may comprise a DRB to Be Modify List IE. The DRB to Be Modify List IE may comprise the third indication.

For example, the DRB to Be Modify List IE may comprise DRB to Be Modify Item IEs. The DRB to Be Modify Item IEs may comprise a “DRB ID” field and the “PSI based discard” IE. The value of the “PSI based discard” IE may indicate the configuration state of PSI based discard for the DRB identified by the “DRB ID” IE.

As described above, in some implementations, the “PSI based discard” IE may comprise the three code points. In the action 480, the value of the “PSI based discard” IE is set to “release”, which indicates the configuration state of PSI based discard for the DRB is “released”.

When the second network node 220 receives the third indication, the second network node 220 determines 485, based on the third indication, release of configuration of the PSI based discard for the DRB. For example, when the second network node 220 receives the “PSI based discard” IE with the value “release”, the second network node 220 determines release of configuration of the PSI based discard for the DRB.

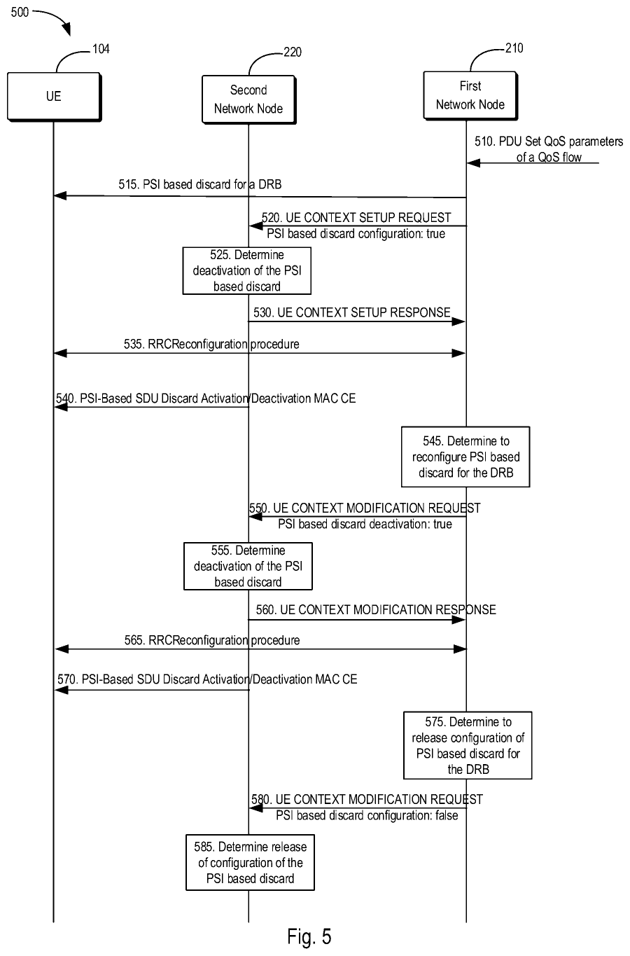

In some implementations, the first network node 210 may transmit the first indication by transmitting a message comprising an indicator to the second network node 220. The indicator is used to determine deactivation of the PSI based discard for the DRB by the second network node 220. This will be described with reference to FIG. 5.

FIG. 5 illustrates a signaling diagram illustrating an example process 500 that supports PSI based discard in accordance with aspects of the present disclosure. The process 500 may be considered as another example implementation of the process 300. The process 500 may involve the UE 104, the first network node 210, the second network node 220 in FIG. 2. For the purpose of discussion, the process 500 will be described with reference to FIG. 2.

Generally, in the process 500, the first network node 210 may be implemented as a gNB-CU, and the second network node 220 may be implemented as a gNB-DU. The first network node 210 transmits a message comprising an indicator to the second network node 220. The indicator is used to determine deactivation of the PSI based discard for the DRB by the second network node 220.

Actions 510, 515, 530, 535, 540, 545, 560, 565, 570 and 575 are similar to the actions 410, 415, 430, 435, 440, 445, 460, 465, 470 and 475 in FIG. 4. Details of these actions are omitted for brevity.

The process 500 is different from the process 400 in actions 520, 525, 550, 555, 580 and 585.

As shown in FIG. 5, upon configuring the UE 104 with the PSI based discard for the DRB, the first network node 210 may transmit the second indication to the second network node 220. The second indication is used to determine deactivation of the PSI based discard for the DRB by the second network node 220.

In some implementations, the first network node 210 may transmit the second indication by transmitting the second information about configuration of the PSI based discard for the DRB. The second information about configuration of the PSI based discard for the DRB indicates that a configuration state of PSI based discard for the DRB is “configured” or indicates that the PSI based discard for the DRB is “configured”. The second information is used to determine deactivation of the PSI based discard for the DRB by the second network node 220.

For example, as shown in FIG. 5, the first network node 210 may transmit 520 a UE CONTEXT SETUP REQUEST message to the second network node 220. The UE CONTEXT SETUP REQUEST message may comprise a DRB to Be Setup List IE. The DRB to Be Setup List IE may comprise the second information about configuration of the PSI based discard for the DRB. Table 2 gives an example of the DRB to Be Setup List IE.

TABLE 2

```
DRB to Be Setup List
  >DRB to Be Setup Item IEs
    >>DRB ID
    >>PSI based discard configuration
```

As shown in Table 2, the DRB to Be Setup List IE may comprise DRB to Be Setup Item IEs. The DRB to Be Setup Item IEs may comprise a “DRB ID” field and a “PSI based discard configuration” IE. A value of the “PSI based discard configuration” IE may indicate a configuration state of PSI based discard for the DRB identified by the “DRB ID” IE.

In some implementations, the “PSI based discard configuration” IE may comprise two code points. For example, PSI based discard configuration::=ENUMERATED {true, false}. A value of the “PSI based discard configuration” IE set to “true” may indicate the configuration state of PSI based discard for the DRB is “configured”. The value of the “PSI based discard configuration” IE set to “false” may indicate the configuration state of PSI based discard for the DRB is “release” or indicate the configuration of PSI based discard for the DRB is “released”. In the action 520, the value of the “PSI based discard configuration” IE is set to “true”.

In some implementations, optionally, the first network node 210 may also indicate the first value of the PSI based discard timer (e.g., 50 ms) to the second network node 220.

When the second network node 220 receives the second information about configuration of the PSI based discard for the DRB, the second network node 220 determines 525, based on the second information, deactivation of the PSI based discard for the DRB. For example, when the second network node 220 receives the “PSI based discard configuration” IE with the value “true”, the second network node 220 determines the PSI based discard for the DRB is configured to the UE 104 and the state of PSI based discard is deactivated.

Upon determining to reconfigure the PSI based discard for the DRB, the first network node 210 transmits the first indication by transmitting a message comprising an indicator to the second network node 220. The indicator is used to determine deactivation of the PSI based discard for the DRB by the second network node 220.

For example, as shown in FIG. 5, the first network node 210 may transmit 550 a UE CONTEXT MODIFICATION REQUEST message to the second network node 220. The UE CONTEXT MODIFICATION REQUEST message may comprise a DRB to Be Modify List IE. The DRB to Be Modify List IE may comprise the indicator. The indicator is used to determine deactivation of the PSI based discard for the DRB by the second network node 220. Table 3 gives an example of the DRB to Be Modify List IE.

TABLE 3

```
DRB to Be Modify List
  >DRB to Be Modify Item IEs
    >>DRB ID
    >>PSI based discard deactivation
```

As shown in Table 3, the DRB to Be Modify List IE may comprise DRB to Be Modify Item IEs. The DRB to Be Modify Item IEs may comprise a “DRB ID” field and a “PSI based discard deactivation” IE. The value of the “PSI based discard deactivation” IE may indicate whether the PSI based discard is deactivated for the DRB identified by the “DRB ID” IE.

In some implementations, the “PSI based discard deactivation” IE may comprise two code points. For example, PSI based discard deactivation::=ENUMERATED {true, false}. A value of the “PSI based discard deactivation” IE set to “true” may indicate that the PSI based discard is deactivated for the DRB identified by the “DRB ID” IE. The value of the “PSI based discard deactivation” IE set to “false” may indicate that the PSI based discard is activated for the DRB identified by the “DRB ID” IE. In the action 550, the value of the “PSI based discard deactivation” IE is set to “true”, which indicates that the PSI based discard is deactivated for the DRB identified by the “DRB ID” IE.

In such implementations, two different IEs (i.e., the “PSI based discard” IE and the “PSI based discard deactivation” IE) are used to indicate whether the PSI based discard is configured or reconfigured when the second network node 220 determines to configure and reconfigure the PSI based discard. Thus, misunderstanding of the second network node 220 may be avoided. In addition, a single IE (i.e., the “PSI based discard” IE) with two code points are used to indicate whether the PSI based discard is configured or released when the second network node 220 determines to configure and release the PSI based discard. Thus, complexity of a signalling may be reduced.

In some implementations, optionally, the first network node 210 may also indicate the second value of the PSI based discard timer to the second network node 220.

When the second network node 220 receives the indicator in the message, the second network node 220 determines 555, based on the indicator, deactivation of the PSI based discard for the DRB. For example, when the second network node 220 receives the “PSI based discard deactivation” IE with the value “true” in the UE CONTEXT MODIFICATION REQUEST message, the second network node 220 determines that the state of PSI based discard is deactivated.

Upon determining to release configuration of the PSI based discard to the UE 104, the first network node 210 may transmit the third indication to the second network node 220. The third indication is used to determine, by the second network node 220, release of configuration of the PSI based discard for the DRB.

For example, as shown in FIG. 5, the first network node 210 may transmit 580 a UE CONTEXT MODIFICATION REQUEST message to the second network node 220. The UE CONTEXT MODIFICATION REQUEST message may comprise a DRB to Be Modify List IE. The DRB to Be Modify List IE may comprise the third indication.

For example, the DRB to Be Modify List IE may comprise a “DRB ID” field and a “PSI based discard configuration” IE. A value of the “PSI based discard configuration” IE may indicate the configuration state of PSI based discard for the DRB identified by the “DRB ID” field. In the action 580, the value of the “PSI based discard configuration” IE is set to “false”, which indicates the configuration state of PSI based discard for the DRB is “released”.

When the second network node 220 receives the third indication, the second network node 220 determines 585, based on the third indication, release of configuration of the PSI based discard for the DRB. For example, when the second network node 220 receives the “PSI based discard configuration” IE with the value “false”, the second network node 220 determines release of configuration of the PSI based discard for the DRB.

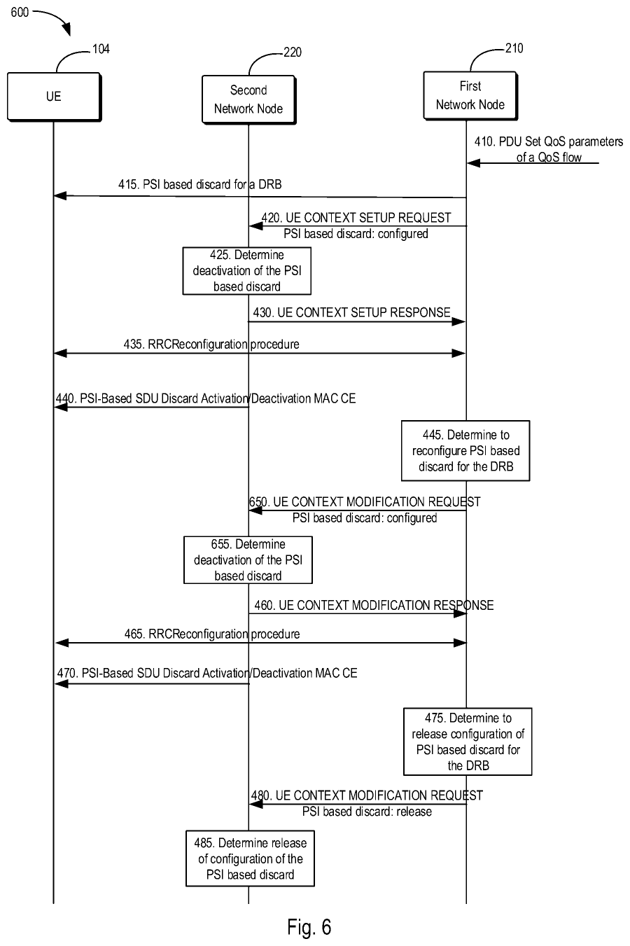

In some implementations, the first network node 210 may transmit the first indication by transmitting, to the second network node 220, first information about configuration of the PSI based discard for the DRB. The first information is used to determine, by the second network node 220, deactivation of the PSI based discard for the DRB. This will be described with reference to FIG. 6.

FIG. 6 illustrates a signaling diagram illustrating an example process 600 that supports PSI based discard in accordance with aspects of the present disclosure. The process 600 may be considered as a further example implementation of the process 300. The process 600 may involve the UE 104, the first network node 210, the second network node 220 in FIG. 2. For the purpose of discussion, the process 600 will be described with reference to FIG. 2.

Generally, in the process 600, the first network node 210 may be implemented as a gNB-CU, and the second network node 220 may be implemented as a gNB-DU. The first network node 210 transmits, to the second network node 220, the first information about configuration of the PSI based discard for the DRB. The first information is used to determine, by the second network node 220, deactivation of the PSI based discard for the DRB.

Actions 410, 415, 420, 425, 430, 435, 440, 445, 460, 465, 470, 475, 480 and 485 are similar to those in FIG. 4. Details of these actions are omitted for brevity.

The process 600 is different from the process 400 in actions 650 and 655.

Specifically, as shown in FIG. 6, upon determining to reconfigure the PSI based discard for the DRB, the first network node 210 may transmit 650 a UE CONTEXT MODIFICATION REQUEST message to the second network node 220. The UE CONTEXT MODIFICATION REQUEST message may comprise a DRB to Be Modify List IE. The DRB to Be Modify List IE may comprise the first information about configuration of the PSI based discard for the DRB. Table 4 gives an example of the DRB to Be Modify List IE.

TABLE 4

```
DRB to Be Modify List
  >DRB to Be Modify Item IEs
    >>DRB ID
    >>PSI based discard
```

As shown in Table 4, the DRB to Be Modify List IE may comprise DRB to Be Modify Item IEs. The DRB to Be Modify Item IEs may comprise a “DRB ID” field and a “PSI based discard” IE. A value of the “PSI based discard” IE may indicate a configuration state of PSI based discard for the DRB identified by the “DRB ID” IE.

In some implementations, the “PSI based discard” IE may comprise two code points. For example, PSI based discard::=ENUMERATED {configured, release, . . . }. A value of the “PSI based discard” IE set to “configured” may indicate the configuration state of PSI based discard for the DRB is “configured”. The value of the “PSI based discard” IE set to “release” may indicate the configuration state of PSI based discard for the DRB is “release” or indicate the configuration of PSI based discard for the DRB is “release”. In the action 650, the value of the “PSI based discard” IE is set to “configured”. In such implementations, a single IE (i.e., the “PSI based discard” IE) is used to indicate whether the PSI based discard is configured when the second network node 220 determines to configure and reconfigure the PSI based discard. Thus, complexity of a signalling is reduced.

When the second network node 220 receives the first information about configuration of the PSI based discard for the DRB, the second network node 220 determines 655, based on the first information, deactivation of the PSI based discard for the DRB. For example, when the second network node 220 receives the “PSI based discard” IE with the value “configured”, the second network node 220 determines the PSI based discard for the DRB is configured to the UE 104 and the state of PSI based discard is deactivated.

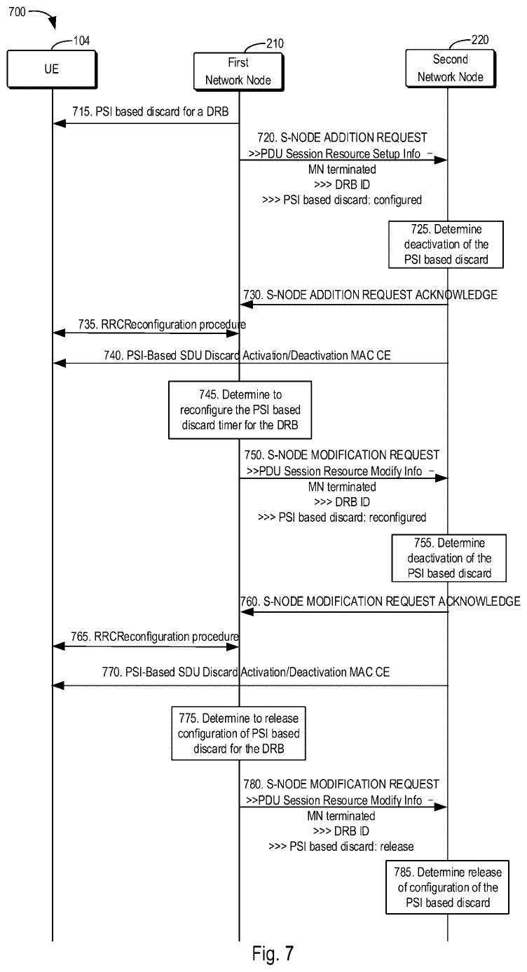

FIG. 7 illustrates a signaling diagram illustrating an example process 700 that supports PSI based discard in accordance with aspects of the present disclosure. The process 700 may be considered as a further example implementation of the process 300. The process 700 may involve the UE 104, the first network node 210, the second network node 220 in FIG. 2. For the purpose of discussion, the process 700 will be described with reference to FIG. 2.

Generally, in the process 700, the first network node 210 may be implemented as an MN hosting a PDCP entity of a DRB, and the second network node 220 may be implemented as a peer node. The DRB may be an MN terminated split bearer or an MN terminated Secondary Cell Group (SCG) bearer. The first network node 210 transmits, to the second network node 220, the first information about reconfiguration of the PSI based discard for the DRB. The first information is used to determine, by the second network node 220, deactivation of the PSI based discard for the DRB.

As shown in FIG. 7, upon determining to configure a PSI based discard timer for a DRB that a QoS flow is mapped to according to the received PDU Set QoS parameters, the first network node 210 configures 715 the UE 104 with PSI based discard for the DRB. The action 715 is similar to the action 310 in FIG. 3. Details of this action is omitted for brevity.

Upon configuring the UE 104 with the PSI based discard for the DRB, the first network node 210 may transmit the second indication to the second network node 220. The second indication is used to determine deactivation of the PSI based discard for the DRB by the second network node 220.

In some implementations, the first network node 210 may transmit the second indication by transmitting second information about configuration of the PSI based discard for the DRB. The second information about configuration of the PSI based discard for the DRB indicates that a configuration state of PSI based discard for the DRB is “configured” or indicates that the PSI based discard for the DRB is “configured”. The second information is used to determine deactivation of the PSI based discard for the DRB by the second network node 220.

For example, as shown in FIG. 7, the first network node 210 may transmit 720 a Secondary NODE (S-NODE) ADDITION REQUEST message to the second network node 220. The S-NODE ADDITION REQUEST message may comprise a PDU Session Resource Setup Info-MN Terminated IE. The PDU Session Resource Setup Info-MN Terminated IE may comprise a DRB to Be Setup List IE. The DRB to Be Setup List IE may comprise the second information about configuration of the PSI based discard for the DRB. Table 1 gives an example of the DRB to Be Setup List IE, as described above with reference to FIG. 4.

As shown in Table 1, the DRB to Be Setup List IE may comprise DRB to Be Setup Item IEs. The DRB to Be Setup Item IEs may comprise a “DRB ID” field and a “PSI based discard” IE. A value of the “PSI based discard” IE may indicate a configuration state of PSI based discard for the DRB identified by the “DRB ID” IE.

As described above, in some implementations, the “PSI based discard” IE may comprise three code points. For example, PSI based discard::=ENUMERATED {configured, reconfigured, release, . . . }. In the action 720, the value of the “PSI based discard” IE is set to “configured”.

In some implementations, optionally, the first network node 210 may also indicate the first value of the PSI based discard timer (e.g., 50 ms) to the second network node 220.

When the second network node 220 receives the second information about configuration of the PSI based discard for the DRB, the second network node 220 determines 725, based on the second information, deactivation of the PSI based discard for the DRB. For example, when receiving the “PSI based discard” IE with the value “configured” in the S-NODE ADDITION REQUEST message, the second network node 220 determines the PSI based discard for the DRB is configured to the UE 104 and the state of PSI based discard is deactivated.

In some implementations, optionally, the second network node 220 may transmit 730 a S-NODE ADDITION REQUEST ACKNOWLEDGE message to the first network node 210.

In some implementations, optionally, an RRC Reconfiguration procedure may be performed 735 between the UE 104 and the first network node 210.

Then, for example, if the second network node 220 detects UL congestion, the second network node 220 may transmit 740 a PSI-Based SDU Discard Activation/Deactivation MAC CE to the UE 104 to activate the PSI based discard for the DRB.

The first network node 210 may determine to change the first value of the PSI based discard timer for the DRB. In this case, the first network node 210 may determine 745 to reconfigure the UE 104 with the PSI based discard. For example, the first network node 210 may determine to change the first value of the PSI based discard timer for the DRB to the second value of the PSI based discard timer for the DRB. In this case, the first network node 210 may determine to reconfigure the UE 104 with the second value of the PSI based discard timer for the DRB.

The first network node 210 transmits the first indication by transmitting the first information about reconfiguration of the PSI based discard for the DRB. The first information about reconfiguration of the PSI based discard for the DRB indicates that a configuration state of PSI based discard for the DRB is “reconfigured” or indicates that the PSI based discard for the DRB is “reconfigured”. The first information is used to determine deactivation of the PSI based discard for the DRB by the second network node 220.

For example, as shown in FIG. 7, the first network node 210 may transmit 750 an S-NODE MODIFICATION REQUEST message to the second network node 220. The S-NODE MODIFICATION REQUEST message may comprise a PDU Session Resource Modify Info-MN Terminated IE. The PDU Session Resource Modify Info-MN Terminated IE may comprise a DRB to Be Modify List IE. The DRB to Be Modify List IE may comprise the first information about reconfiguration of the PSI based discard for the DRB.

For example, the DRB to Be Modify List IE may comprise DRB to Be Modify Item IEs. The DRB to Be Modify Item IEs may comprise a “DRB ID” field and the “PSI based discard” IE. The value of the “PSI based discard” IE may indicate the configuration state of PSI based discard for the DRB identified by the “DRB ID” IE.

As described above, in some implementations, the “PSI based discard” IE may comprise the three code points. In the action 750, the value of the “PSI based discard” IE is set to “reconfigured”, which indicates the configuration state of PSI based discard for the DRB is “reconfigured”.

In some implementations, optionally, the first network node 210 may also indicate the second value of the PSI based discard timer to the second network node 220.

When the second network node 220 receives the first information about reconfiguration of the PSI based discard for the DRB, the second network node 220 determines 755, based on the first information, deactivation of the PSI based discard for the DRB. For example, when receiving the “PSI based discard” IE with the value “reconfigured” in the S-NODE MODIFICATION REQUEST message, the second network node 220 determines the PSI based discard for the DRB is reconfigured to the UE 104 and the state of PSI based discard is deactivated.

In some implementations, optionally, the second network node 220 may transmit 760 an S-NODE MODIFICATION REQUEST ACKNOWLEDGE message to the first network node 210.

In some implementations, optionally, an RRC Reconfiguration procedure may be performed 765 between the UE 104 and the first network node 210.

Then, for example, if the second network node 220 detects UL congestion, the second network node 220 may transmit 770 a PSI-Based SDU Discard Activation/Deactivation MAC CE to the UE 104 to activate the PSI based discard for the DRB.

The first network node 210 may determine 775 to release configuration of the PSI based discard to the UE 104. In this case, the first network node 210 releases the configuration of the PSI based discard to the UE 104.

In turn, the first network node 210 may transmit the third indication to the second network node 220. The third indication is used to determine, by the second network node 220, release of configuration of the PSI based discard for the DRB.

For example, as shown in FIG. 7, the first network node 210 may transmit 780 an S-NODE MODIFICATION REQUEST message to the second network node 220. The S-NODE MODIFICATION REQUEST message may comprise a PDU Session Resource Modify Info-MN Terminated IE. The PDU Session Resource Modify Info-MN Terminated IE may comprise a DRB to Be Modify List IE. The DRB to Be Modify List IE may comprise the third indication.

For example, the DRB to Be Modify List IE may comprise DRB to Be Modify Item IEs. The DRB to Be Modify Item IEs may comprise a “DRB ID” field and the “PSI based discard” IE. The value of the “PSI based discard” IE may indicate the configuration state of PSI based discard for the DRB identified by the “DRB ID” IE.

As described above, in some implementations, the “PSI based discard” IE may comprise the three code points. In the action 780, the value of the “PSI based discard” IE is set to “release”, which indicates the configuration state of PSI based discard for the DRB is “released”.

When the second network node 220 receives the third indication, the second network node 220 determines 785, based on the third indication, release of configuration of the PSI based discard for the DRB. For example, when receiving the “PSI based discard” IE with the value “release” in the S-NODE MODIFICATION REQUEST message, the second network node 220 determines release of configuration of the PSI based discard for the DRB.

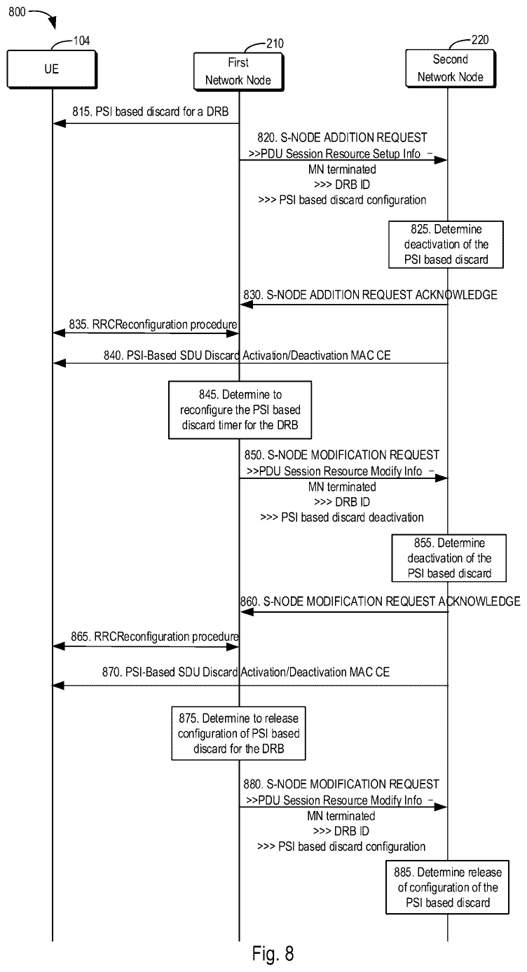

FIG. 8 illustrates a signaling diagram illustrating an example process 800 that supports PSI based discard in accordance with aspects of the present disclosure. The process 800 may be considered as another example implementation of the process 300. The process 800 may involve the UE 104, the first network node 210, the second network node 220 in FIG. 2. For the purpose of discussion, the process 800 will be described with reference to FIG. 2.

Generally, in the process 800, the first network node 210 may be implemented as an MN hosting a PDCP entity of a DRB, and the second network node 220 may be implemented as a peer node. The DRB may be an MN terminated split bearer or an MN terminated Secondary Cell Group (SCG) bearer. The first network node 210 transmits a message comprising an indicator to the second network node 220. The indicator is used to determine deactivation of the PSI based discard for the DRB by the second network node 220.

Actions 810, 815, 830, 835, 840, 845, 860, 865, 870 and 875 are similar to the actions 710, 715, 730, 735, 770, 775, 760, 765, 770 and 775 in FIG. 7. Details of these actions are omitted for brevity.

The process 800 is different from the process 700 in actions 820, 825, 850, 855, 880 and 885.

As shown in FIG. 8, upon configuring the UE 104 with the PSI based discard for the DRB, the first network node 210 may transmit the second indication to the second network node 220. The second indication is used to determine deactivation of the PSI based discard for the DRB by the second network node 220.

In some implementations, the first network node 210 may transmit the second indication by transmitting the second information about configuration of the PSI based discard for the DRB. The second information about configuration of the PSI based discard for the DRB indicates that a configuration state of PSI based discard for the DRB is “configured” or indicates that the PSI based discard for the DRB is “configured”. The second information is used to determine deactivation of the PSI based discard for the DRB by the second network node 220.

For example, as shown in FIG. 8, the first network node 210 may transmit 820 an S-NODE ADDITION REQUEST message to the second network node 220. The S-NODE ADDITION REQUEST message may comprise a PDU Session Resource Setup Info-MN Terminated IE. The PDU Session Resource Setup Info-MN Terminated IE may comprise a DRB to Be Setup List IE. The DRB to Be Setup List IE may comprise the second information about configuration of the PSI based discard for the DRB. Table 2 gives an example of the DRB to Be Setup List IE, as described above with reference to FIG. 5.

As shown in Table 2, the DRB to Be Setup List IE may comprise DRB to Be Setup Item IEs. The DRB to Be Setup Item IEs may comprise a “DRB ID” field and a “PSI based discard configuration” IE. A value of the “PSI based discard configuration” IE may indicate a configuration state of PSI based discard for the DRB identified by the “DRB ID” IE.

In the process 800, the “PSI based discard configuration” IE may comprise two code points. For example, PSI based discard configuration::=ENUMERATED {true, false}. A value of the “PSI based discard configuration” IE set to “true” may indicate the configuration state of PSI based discard for the DRB is “configured”. A value of the “PSI based discard configuration” IE set to “false” may indicate the configuration state of PSI based discard for the DRB is “release” or indicate the configuration of PSI based discard for the DRB is “released”. In the action 820, the value of the “PSI based discard configuration” IE is set to “true”.

In some implementations, optionally, the first network node 210 may also indicate the first value of the PSI based discard timer (e.g., 50 ms) to the second network node 220.

When the second network node 220 receives the second information about configuration of the PSI based discard for the DRB, the second network node 220 determines 825, based on the second information, deactivation of the PSI based discard for the DRB. For example, when the second network node 220 receives the “PSI based discard configuration” IE with the value “true”, the second network node 220 determines the PSI based discard for the DRB is configured to the UE 104 and the state of PSI based discard is deactivated.

Upon determining to reconfigure the PSI based discard for the DRB, the first network node 210 transmits the first indication by transmitting a message comprising an indicator to the second network node 220. The indicator is used to determine deactivation of the PSI based discard for the DRB by the second network node 220.

For example, as shown in FIG. 8, the first network node 210 may transmit 850 an S-NODE MODIFICATION REQUEST message to the second network node 220. The S-NODE MODIFICATION REQUEST message may comprise a PDU Session Resource Modify Info-MN Terminated IE. The PDU Session Resource Modify Info-MN Terminated IE may comprise a DRB to Be Modify List IE. The DRB to Be Modify List IE may comprise the indicator. The indicator is used to determine deactivation of the PSI based discard for the DRB by the second network node 220. Table 3 gives an example of the DRB to Be Setup List IE, as described with reference to FIG. 5.

As shown in Table 3, the DRB to Be Modify List IE may comprise DRB to Be Modify Item IEs. The DRB to Be Modify Item IEs may comprise a “DRB ID” field and a “PSI based discard deactivation” IE. The value of the “PSI based discard deactivation” IE may indicate whether the PSI based discard is deactivated for the DRB identified by the “DRB ID” IE.

In some implementations, the “PSI based discard deactivation” IE may comprise two code points. For example, PSI based discard deactivation::=ENUMERATED {true, false}. In the action 850, the value of the “PSI based discard deactivation” IE is set to “true”, which indicates that the PSI based discard is deactivated for the DRB identified by the “DRB ID” IE.

In some implementations, optionally, the first network node 210 may also indicate the second value of the PSI based discard timer to the second network node 220.

When the second network node 220 receives the indicator in the message, the second network node 220 determines 855, based on the indicator, deactivation of the PSI based discard for the DRB. For example, when receiving the “PSI based discard deactivation” IE with the value “true” in the S-NODE MODIFICATION REQUEST message, the second network node 220 determines that the state of PSI based discard is deactivated.

Upon determining to release configuration of the PSI based discard to the UE 104, the first network node 210 may transmit the third indication to the second network node 220. The third indication is used to determine, by the second network node 220, release of configuration of the PSI based discard for the DRB.

For example, as shown in FIG. 8, the first network node 210 may transmit 880 an S-NODE MODIFICATION REQUEST message to the second network node 220. The S-NODE MODIFICATION REQUEST message may comprise a PDU Session Resource Modify Info-MN Terminated IE. The PDU Session Resource Modify Info-MN Terminated IE may comprise a DRB to Be Modify List IE. The DRB to Be Modify List IE may comprise the third indication.

For example, the DRB to Be Modify List IE may comprise a “DRB ID” field and a “PSI based discard configuration” IE. In the action 880, the value of the “PSI based discard configuration” IE is set to “false”, which indicates the configuration state of PSI based discard for the DRB is “released”.

When the second network node 220 receives the third indication, the second network node 220 determines 885, based on the third indication, release of configuration of the PSI based discard for the DRB. For example, when receiving the “PSI based discard configuration” IE with the value “false” in the S-NODE MODIFICATION REQUEST message, the second network node 220 determines release of configuration of the PSI based discard for the DRB.

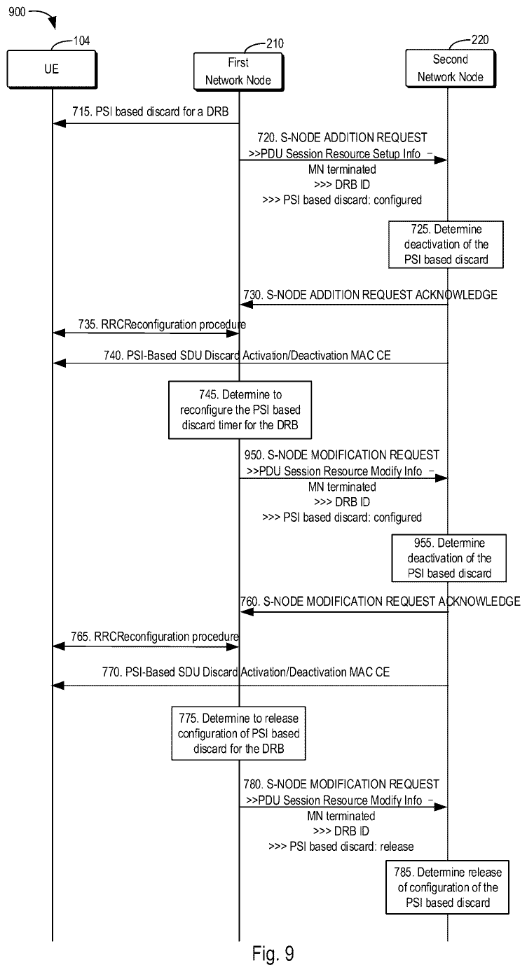

FIG. 9 illustrates a signaling diagram illustrating an example process 900 that supports PSI based discard in accordance with aspects of the present disclosure. The process 900 may be considered as a further example implementation of the process 300. The process 900 may involve the UE 104, the first network node 210, the second network node 220 in FIG. 2. For the purpose of discussion, the process 900 will be described with reference to FIG. 2.

Generally, in the process 900, the first network node 210 may be implemented as an MN hosting a PDCP entity of a DRB, and the second network node 220 may be implemented as a peer node. The DRB may be an MN terminated split bearer or an MN terminated SCG bearer. The first network node 210 transmits, to the second network node 220, the first information about configuration of the PSI based discard for the DRB. The first information is used to determine, by the second network node 220, deactivation of the PSI based discard for the DRB.

Actions 710, 715, 720, 725, 730, 735, 740, 745, 760, 765, 770, 775, 780 and 785 are similar to those in FIG. 7. Details of these actions are omitted for brevity.

The process 900 is different from the process 400 in actions 950 and 955.

Specifically, as shown in FIG. 9, upon determining to reconfigure the PSI based discard for the DRB, the first network node 210 may transmit 950 an S-NODE MODIFICATION REQUEST message to the second network node 220. The S-NODE MODIFICATION REQUEST message may comprise a PDU Session Resource Modify Info-MN Terminated IE. The PDU Session Resource Modify Info-MN Terminated IE may comprise a DRB to Be Modify List IE. The DRB to Be Modify List IE may comprise the first information about configuration of the PSI based discard for the DRB. Table 4 gives an example of the DRB to Be Modify List IE, as described with reference to FIG. 6.

As shown in Table 4, the DRB to Be Modify List IE may comprise DRB to Be Modify Item IEs. The DRB to Be Modify Item IEs may comprise a “DRB ID” field and a “PSI based discard” IE. A value of the “PSI based discard” IE may indicate a configuration state of PSI based discard for the DRB identified by the “DRB ID” IE.

In some implementations, the “PSI based discard” IE may comprise two code points. For example, PSI based discard: =ENUMERATED {configured, release, . . . }. In the action 950, the value of the “PSI based discard” IE is set to “configured”. In such implementations, a single IE (i.e., the “PSI based discard” IE) is used to indicate whether the PSI based discard is configured when the second network node 220 determines to configure and reconfigure the PSI based discard. Thus, complexity of a signalling is reduced.

When the second network node 220 receives the first information about configuration of the PSI based discard for the DRB, the second network node 220 determines 955, based on the first information, deactivation of the PSI based discard for the DRB. For example, when receiving the “PSI based discard” IE with the value “configured” in the S-NODE MODIFICATION REQUEST message, the second network node 220 determines the PSI based discard for the DRB is configured to the UE 104 and the state of PSI based discard is deactivated.

It shall be understood that the processes 700, 800 and 900 are described by taking MN terminated split bearer and MN terminated SCG bearer as example. The processes 700, 800 and 900 may be applied to SN terminated bearer if the roles of MN and SN are exchanged. The SN terminated bearer may be SN terminated split bearer or SN terminated Master Cell Group (MCG) bearer.

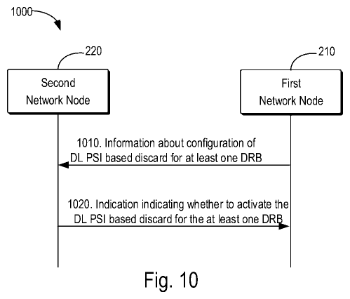

FIG. 10 illustrates a signaling diagram illustrating an example process 1000 that supports PSI based discard in accordance with aspects of the present disclosure. The process 1000 may involve the first network node 210 and the second network node 220 in FIG. 2. For the purpose of discussion, the process 1000 will be described with reference to FIG. 2.

As shown in FIG. 10, the first network node 210 transmits 1010, to the second network node 220, information about configuration of downlink (DL) PSI based discard for at least one DRB.

In some implementations, the information about configuration of DL PSI based discard for at least one DRB may indicate that DL PSI based discard is configured for the at least one DRB at the first network node 210.

The first network node 210 receives 1020, from the second network node 220, an indication indicating whether to activate the downlink PSI based discard for the at least one DRB.

The process 1000 supports DL PSI discard activation/deactivation between the second network node 220 and the first network node 210.

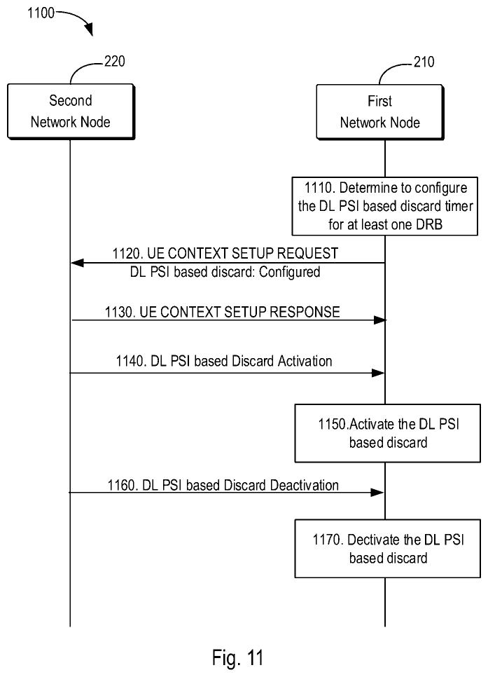

FIG. 11 illustrates a signaling diagram illustrating an example process 1100 that supports PSI based discard in accordance with aspects of the present disclosure. The process 1100 may be considered as an example implementation of the process 1000. The process 1100 may involve the first network node 210 and the second network node 220 in FIG. 2. For the purpose of discussion, the process 1100 will be described with reference to FIG. 2.

Generally, in the process 1100, the first network node 210 may be implemented as a gNB-CU, and the second network node 220 may be implemented as a gNB-DU. The first network node 210 may comprise a gNB-CU-CP and a gNB-CU-UP. The PSI based discard function may be performed at the first network node 210. For example, the PSI based discard function may be performed at the gNB-CU-UP.

As shown in FIG. 11, the first network node 210 determines 1110 to configure DL PSI based discard timer for at least one DRB. For example, the gNB-CU-CP may configure the gNB-CU-UP with the DL PSI based discard timer for the at least one DRB.

In turn, the first network node 210 transmits, to the second network node 220, information about configuration of the DL PSI based discard for the at least one DRB. The information about configuration of DL PSI based discard for at least one DRB may indicate that DL PSI based discard is configured for the at least one DRB at the first network node 210.

For example, the first network node 210 may transmit 1120, to the second network node 220, an F1-AP UE CONTEXT SETUP REQUEST message or UE CONTEXT MODIFICAION REQUEST message. The F1-AP UE CONTEXT SETUP REQUEST message or UE CONTEXT MODIFICAION REQUEST message may comprise a DL PSI based discard IE. A value of the DL PSI based discard IE set to “configured” may indicate that the DL PSI based discard is configured for the at least one DRB at the first network node 210. The initial state of the DL PSI based discard could be “deactivated”.

As response, the second network node 220 may transmit 1130, to the first network node 210, an F1-AP UE CONTEXT SETUP RESPONSE message or UE CONTEXT MODIFICAION RESPONSE message.

In turn, the second network node 220 may determine to activate the DL PSI based discard for the at least one DRB. For example, in case of the second network node 220 detects network congestion, the second network node 220 transmits a DL PSI based Discard Activation Indication to the first network node 210. The DL PSI based Discard Activation Indication indicates to activate the DL PSI based discard for the at least one DRB.

When receiving the DL PSI based Discard Activation Indication, the first network node 210 activates 1150 the DL PSI based discard for the at least one DRB.

In some implementations, at reception of a PDCP SDU from the CN 106, if the DL PSI based discard is configured and activated and if the PDCP SDU belongs to low or lower importance data (e.g., the PDCP SDU is associated with a PSI value), the transmitting PDCP entity of the first network node 210 may start a DL PSI based discard timer associated with this PDCP SDU. If the DL PSI based discard is deactivated and/or the PDCP SDU does not belong to low or lower importance data (e.g., the PDCP SDU is not associated with the PSI value), the transmitting PDCP entity of the first network node 210 may start a legacy DL PDCP discard timer associated with this PDCP SDU (if configured). A value of the DL PSI based discard timer may be different from a value of the legacy DL PDCP discard timer. For example, the value of the DL PSI based discard timer may be shorter than the value of the legacy DL PDCP discard timer.

The second network node 220 may also determine to deactivate the DL PSI based Discard for the at least one DRB. For example, in case of the second network node 220 detects network is not congested anymore, the second network node 220 may deactivate the DL PSI based discard for the at least one DRB. The second network node 220 may transmit 1160 a DL PSI based Discard Deactivation Indication to the first network node 210. The DL PSI based Discard Deactivation Indication indicates to deactivate the DL PSI based discard for the at least one DRB.

When receiving the DL PSI based Discard Deactivation Indication, the first network node 210 deactivates 1170 the DL PSI based discard for the at least one DRB. For example, the first network node 210 starts the legacy discard timer for new incoming data from the CN 106.

In some implementations, the second network node 220 may transmit the indication by transmitting, to the first network node 210, a General Packet Radio Service (GPRS) Tunnel Protocol-User Plane (GTP-U) extension header which comprises the indication. The indication indicates whether to activate the downlink PSI based discard for the at least one DRB.

In such implementations, the GTP-U extension header may comprise a PDU Set Information container. The PDU Set Information container may comprise the DL PSI based Discard Activation Indication or the DL PSI based Discard Deactivation Indication. For example, a dedicated or new frame is defined for the DL PSI based Discard Activation Indication or the DL PSI based Discard Deactivation Indication.

In some implementations, the DL PSI based Discard Activation Indication and/or the DL PSI based Discard Deactivation Indication may be per DRB. Alternatively, the DL PSI based Discard Activation Indication and/or the DL PSI based Discard Deactivation Indication may indicate to activate or deactivate multiple DRBs. In such implementations, the DL PSI based Discard Activation Indication in the GTP-U extension header may comprise a bitmap. Each of at least one bit in the bitmap is associated with one of the at least one DRB, and each of the at least one bit indicates whether to activate the downlink PSI based discard for a respective one of the at least one DRB.

For example, the GTP-U extension header may comprise a field which indicates activation/deactivation status of the PSI-based SDU discard of DRB i, where i is the ascending order of the DRB IDs among the DRBs configured with DL PSI based discard. The Di field set to 1 indicates that the DL PSI based discard shall be activated for DRB i. The Di field set to 0 indicates that the DL PSI based discard shall be deactivated for DRB i.

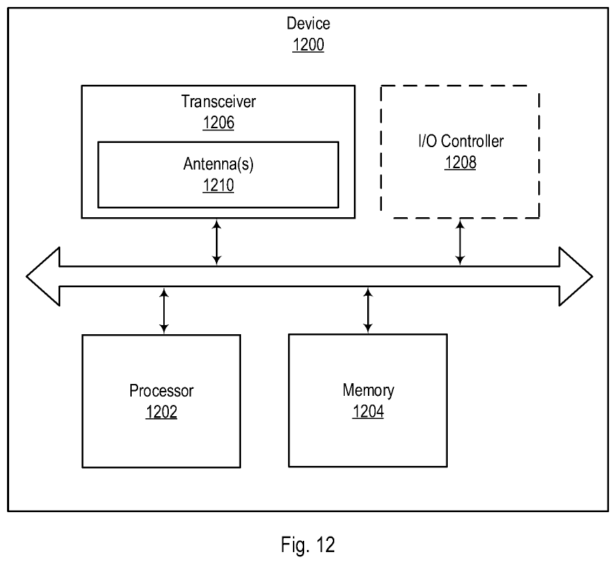

FIG. 12 illustrates an example of a device 1200 that supports PSI based discard in accordance with aspects of the present disclosure. The device 1200 may be an example of a network entity 102, the first network node 210, or the second network node 220 as described herein. The device 1200 may support wireless communication with one or more network entities 102, UEs 104, or any combination thereof. The device 1200 may include components for bi-directional communications including components for transmitting and receiving communications, such as a processor 1202, a memory 1204, a transceiver 1206, and, optionally, an I/O controller 1208. These components may be in electronic communication or otherwise coupled (e.g., operatively, communicatively, functionally, electronically, electrically) via one or more interfaces (e.g., buses).

The processor 1202, the memory 1204, the transceiver 1206, or various combinations thereof or various components thereof may be examples of means for performing various aspects of the present disclosure as described herein. For example, the processor 1202, the memory 1204, the transceiver 1206, or various combinations or components thereof may support a method for performing one or more of the operations described herein.

In some implementations, the processor 1202, the memory 1204, the transceiver 1206, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1202 and the memory 1204 coupled with the processor 1202 may be configured to perform one or more of the functions described herein (e.g., executing, by the processor 1202, instructions stored in the memory 1204).

For example, the processor 1202 may support wireless communication at the device 1200 in accordance with examples as disclosed herein. The processor 1202 may be configured to operable to support a means for performing the following: configuring a UE with PSI based discard for a DRB; determining to reconfigure the UE with the PSI based discard for the DRB; and transmitting a first indication to a second network node, wherein the first indication is used to determine deactivation of the PSI based discard for the DRB by the second network node.

Alternatively, in some implementations, the processor 1202 may be configured to operable to support a means for performing the following: receiving a first indication from a first network node, wherein the first indication is used to determine deactivation of PSI based discard for a DRB by the second network node; and determining, based on the first indication, the deactivation of the PSI based discard timer for the DRB.

Alternatively, in some implementations, the processor 1202 may be configured to operable to support a means for performing the following: transmitting, to a second network node, information about configuration of downlink PSI based discard for at least one DRB; and receiving, from the second network node, an indication indicating whether to activate the downlink PSI based discard for the at least one DRB.

Alternatively, in some implementations, the processor 1202 may be configured to operable to support a means for performing the following: receiving, from a first network node, information about configuration of at least one downlink PSI based discard for at least one DRB; and transmitting, to the first network node, an indication indicating whether to activate the at least one downlink PSI based discard for the at least one DRB.

The processor 1202 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1202 may be configured to operate a memory array using a memory controller. In some other implementations, a memory controller may be integrated into the processor 1202. The processor 1202 may be configured to execute computer-readable instructions stored in a memory (e.g., the memory 1204) to cause the device 1200 to perform various functions of the present disclosure.

The memory 1204 may include random access memory (RAM) and read-only memory (ROM). The memory 1204 may store computer-readable, computer-executable code including instructions that, when executed by the processor 1202 cause the device 1200 to perform various functions described herein. The code may be stored in a non-transitory computer-readable medium such as system memory or another type of memory. In some implementations, the code may not be directly executable by the processor 1202 but may cause a computer (e.g., when compiled and executed) to perform functions described herein. In some implementations, the memory 1204 may include, among other things, a basic I/O system (BIOS) which may control basic hardware or software operation such as the interaction with peripheral components or devices.

The I/O controller 1208 may manage input and output signals for the device 1200. The I/O controller 1208 may also manage peripherals not integrated into the device M02. In some implementations, the I/O controller 1208 may represent a physical connection or port to an external peripheral. In some implementations, the I/O controller 1208 may utilize an operating system such as iOS®, ANDROID®, MS-WINDOWS®, OS/2®, UNIX®, LINUX®, or another known operating system. In some implementations, the I/O controller 1208 may be implemented as part of a processor, such as the processor 1206. In some implementations, a user may interact with the device 1200 via the I/O controller 1208 or via hardware components controlled by the I/O controller 1208.

In some implementations, the device 1200 may include a single antenna 1210. However, in some other implementations, the device 1200 may have more than one antenna 1210 (i.e., multiple antennas), including multiple antenna panels or antenna arrays, which may be capable of concurrently transmitting or receiving multiple wireless transmissions. The transceiver 1206 may communicate bi-directionally, via the one or more antennas 1210, wired, or wireless links as described herein. For example, the transceiver 1206 may represent a wireless transceiver and may communicate bi-directionally with another wireless transceiver. The transceiver 1206 may also include a modem to modulate the packets, to provide the modulated packets to one or more antennas 1210 for transmission, and to demodulate packets received from the one or more antennas 1210. The transceiver 1206 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 1210 for transmitting the amplified signal into the air or wireless medium.

A receive chain may be configured to receive signals (e.g., control information, data, packets) over a wireless medium. For example, the receive chain may include one or more antennas 1210 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

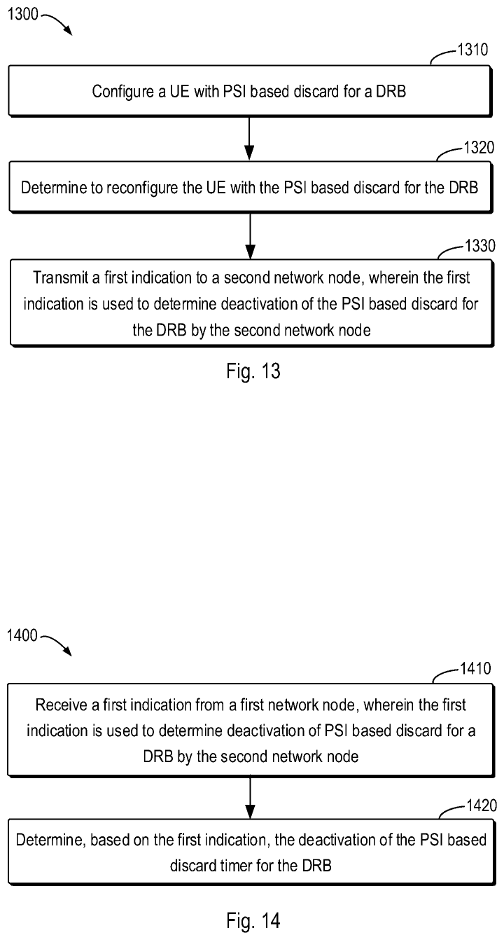

FIG. 13 illustrates a flowchart of a method 1300 that supports PSI based discard in accordance with aspects of the present disclosure. The operations of the method 1300 may be implemented by a device or its components as described herein. For example, the operations of the method 1300 may be performed by the first network node 210 as described herein. In some implementations, the device may execute a set of instructions to control the function elements of the device to perform the described functions. Additionally, or alternatively, the device may perform aspects of the described functions using special-purpose hardware.

At 1310, the method may include configuring a UE with PSI based discard for a DRB. The operations of 1310 may be performed in accordance with examples as described herein. In some implementations, aspects of the operations of 1310 may be performed by a device as described with reference to FIG. 2.

At 1320, the method may include determining to reconfigure the UE with the PSI based discard for the DRB. The operations of 1320 may be performed in accordance with examples as described herein. In some implementations, aspects of the operations of 1320 may be performed by a device as described with reference to FIG. 2.

At 1330, the method may include transmitting a first indication to a second network node. The first indication is used to determine deactivation of the PSI based discard for the DRB by the second network node. The operations of 1330 may be performed in accordance with examples as described herein. In some implementations, aspects of the operations of 1330 may be performed by a device as described with reference to FIG. 2.

FIG. 14 illustrates a flowchart of a method 1400 that supports PSI based discard in accordance with aspects of the present disclosure. The operations of the method 1400 may be implemented by a device or its components as described herein. For example, the operations of the method 1400 may be performed by the second network node 220 as described herein. In some implementations, the device may execute a set of instructions to control the function elements of the device to perform the described functions. Additionally, or alternatively, the device may perform aspects of the described functions using special-purpose hardware.

At 1410, the method may include receiving a first indication from a first network node. The first indication is used to determine deactivation of PSI based discard for a DRB by the second network node. The operations of 1410 may be performed in accordance with examples as described herein. In some implementations, aspects of the operations of 1410 may be performed by a device as described with reference to FIG. 2.

At 1420, the method may include determining, based on the first indication, the deactivation of the PSI based discard timer for the DRB. The operations of 1420 may be performed in accordance with examples as described herein. In some implementations, aspects of the operations of 1420 may be performed by a device as described with reference to FIG. 2.

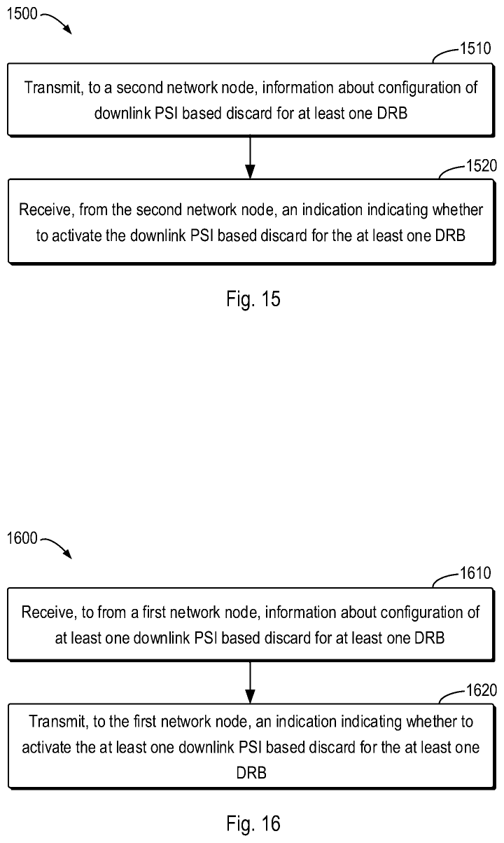

FIG. 15 illustrates a flowchart of a method 1500 that supports PSI based discard in accordance with aspects of the present disclosure. The operations of the method 1500 may be implemented by a device or its components as described herein. For example, the operations of the method 1500 may be performed by the first network node 210 as described herein. In some implementations, the device may execute a set of instructions to control the function elements of the device to perform the described functions. Additionally, or alternatively, the device may perform aspects of the described functions using special-purpose hardware.

At 1510, the method may include transmitting, to a second network node, information about configuration of downlink PSI based discard for at least one DRB. The operations of 1510 may be performed in accordance with examples as described herein. In some implementations, aspects of the operations of 1510 may be performed by a device as described with reference to FIG. 2.

At 1520, the method may include receiving, from the second network node, an indication indicating whether to activate the downlink PSI based discard for the at least one DRB. The operations of 1520 may be performed in accordance with examples as described herein. In some implementations, aspects of the operations of 1520 may be performed by a device as described with reference to FIG. 2.

FIG. 16 illustrates a flowchart of a method 1600 that supports PSI based discard in accordance with aspects of the present disclosure. The operations of the method 1600 may be implemented by a device or its components as described herein. For example, the operations of the method 1600 may be performed by the second network node 220 as described herein. In some implementations, the device may execute a set of instructions to control the function elements of the device to perform the described functions. Additionally, or alternatively, the device may perform aspects of the described functions using special-purpose hardware.

At 1610, the method may include receiving, from a first network node, information about configuration of at least one downlink PSI based discard for at least one DRB. The operations of 1610 may be performed in accordance with examples as described herein. In some implementations, aspects of the operations of 1610 may be performed by a device as described with reference to FIG. 2.

At 1620, the method may include transmitting, to the first network node, an indication indicating whether to activate the at least one downlink PSI based discard for the at least one DRB. The operations of 1620 may be performed in accordance with examples as described herein. In some implementations, aspects of the operations of 1620 may be performed by a device as described with reference to FIG. 2.

It shall be noted that implementations of the present disclosure which have been described with reference to FIGS. 1 to 11 are also applicable to the device 1200 as well as the methods 1300, 1400, 1500 and 1600.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
at least one memory; and
at least one processor coupled with the at least one memory and configured to cause the first network node to:
configure a user equipment (UE) with protocol data unit set importance (PSI) based discard for a data radio bearer (DRB);
determine to reconfigure the UE with the PSI based discard for the DRB; and
transmit a first indication for determining deactivation of the PSI based discard for the DRB by a second network node.

2. The first network node of claim 1, wherein to transmit the first indication, the at least one processor is configured to cause the first network node to:
transmit first information about configuration or reconfiguration of the PSI based discard for the DRB, wherein the first information is for determining deactivation of the PSI based discard for the DRB by the second network node.

3. The first network node of claim 1, wherein to transmit the first indication, the at least one processor is configured to cause the first network node to:
transmit a message comprising an indicator for determining deactivation of the PSI based discard for the DRB by the second network node.

4. The first network node of claim 1, wherein the at least one processor is further configured to cause the first network node to:
upon configuring the UE with the PSI based discard for the DRB, transmit a second indication for determining deactivation of the PSI based discard for the DRB by the second network node.

5. The first network node of claim 4, wherein to transmit the second indication, the at least one processor is configured to cause the first network node to:
transmit second information about configuration of the PSI based discard for the DRB, wherein the second information is for determining deactivation of the PSI based discard for the DRB by the second network node.

6. The first network node of claim 1, wherein the at least one processor is further configured to cause the first network node to:
transmit a third indication for determining release of configuration of the PSI based discard for the DRB by the second network node.

7. The first network node of claim 1, wherein the first network node comprises a central unit (CU) of a gNodeB, and the second network node comprises a distributed unit (DU) of the gNodeB.

8. A second network node, comprising:
at least one memory; and
at least one processor coupled with the at least one memory and configured to cause the second network node to:
receive a first indication for determining deactivation of protocol data unit set importance (PSI) based discard for a data radio bearer (DRB) by the second network node; and
determine, based at least in part on the first indication, the deactivation of a PSI based discard timer for the DRB.

9. The second network node of claim 8, wherein to receive the first indication, the at least one processor is configured to cause the second network node to:
receive first information about configuration or reconfiguration of the PSI based discard for the DRB, wherein the first information is for determining deactivation of the PSI based discard for the DRB by the second network node.

10. The second network node of claim 8, wherein to receive the first indication, the at least one processor is configured to cause the second network node to:
receive a message comprising an indicator for determining deactivation of the PSI based discard for the DRB by the second network node.

11. The second network node of claim 8, wherein the at least one processor is further configured to cause the second network node to:
after a user equipment (UE) is configured with the PSI based discard for the DRB, receive a second indication for determining deactivation of the PSI based discard for the DRB by the second network node.

12. The second network node of claim 11, wherein to receive the second indication, the at least one processor is configured to cause the second network node to:
receive second information about configuration of the PSI based discard for the DRB, wherein the second information is for determining deactivation of the PSI based discard for the DRB by the second network node.

13. The second network node of claim 8, wherein the at least one processor is further configured to cause the second network node to:
receive a third indication for determining release of configuration of the PSI based discard for the DRB by the second network node.

14. The second network node of claim 8, wherein the first network node comprises a node hosting a packet data convergence protocol (PDCP) entity of the DRB, and the second network node comprises a peer node of the node hosting the PDCP entity.

15. A first network node, comprising:
at least one memory; and
at least one processor coupled with the at least one memory and configured to cause the first network node to:
transmit information about configuration of downlink protocol data unit set importance (PSI) based discard for at least one data radio bearer (DRB); and
receive an indication indicating whether to activate the downlink PSI based discard for the at least one DRB.

16. The first network node of claim 15, wherein to receive the indication, the at least one processor is configured to cause the first network node to:
receive a general packet radio service (GPRS) tunnel protocol-user plane (GTP-U) extension header which comprises the indication.

17. The first network node of claim 16, wherein the GTP-U extension header comprises a bitmap, wherein each of at least one bit in the bitmap is associated with one of the at least one DRB, and each of the at least one bit indicates whether to activate the downlink PSI based discard for a respective one of the at least one DRB.

18. A second network node, comprising:
at least one memory; and
at least one processor coupled with the at least one memory and configured to cause the second network node to:
receive information about configuration of at least one downlink protocol data unit set importance (PSI) based discard for at least one data radio bearer (DRB); and
transmit an indication indicating whether to activate the at least one downlink PSI based discard for the at least one DRB.

19. The second network node of claim 18, wherein to transmit the indication, the at least one processor is configured to cause the second network node to:
transmit a general packet radio service (GPRS) Tunnel Protocol-User Plane tunnel protocol-user plane (GTP-U) extension header which comprises the indication.

20. The second network node of claim 19, wherein the GTP-U extension header comprises a bitmap, wherein each of at least one bit in the bitmap is associated with one of the at least one DRB, and each of the at least one bit indicates whether to activate the downlink PSI based discard for a respective one of the at least one DRB.
